(19) United States
(12) Patent Application Publication
(10) Pub. No.: US 2001/0041155 A1
(43) Pub. Date: Nov. 15, 2001

(54) Ozone generator

(75) Inventor: Wayne Conrad, Hampton (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Fantom Technologies Inc.

(21) Appl. No.: 09/758,247

(22) Filed: Jan. 12, 2001

(30) Foreign Application Priority Data
Jan. 14, 2000 (CA) 2,296,130

(51) Int. Cl. B01J 19/08

(52) U.S. Cl. 422/186.18

(57) ABSTRACT

An ozone generator comprises an electrically insulating housing and a high voltage electrode, a ground electrode and a dielectric element positioned within the housing.

### FIELD OF THE INVENTION

This invention is directed to an apparatus for producing ozone from a gas mixture comprising or containing oxygen.

### BACKGROUND OF THE INVENTION

Ozone generators are known which employ corona discharge to produce ozone from oxygen by action of oxygen atoms on oxygen molecules. The generators typically employ voltages in excess of 20,0000 volts and frequencies of 50 to 5,000 Hz. The high voltage transformers and the general geometry of the generators is large and they are difficult to construct and maintain. Accordingly, such ozone generators are typically assembled by hand thereby causing them to be expensive and difficult to produce in large quantities.

Overall, such generators are not adaptable for the manufacture on a high throughput basis which would be required for use of the ozone generator in an electrical apparatus for retail consumer sale. Further, such ozone generators are not suitable for inclusion in consumer appliances due to their large size and geometry.

### SUMMARY OF THE PRESENT INVENTION

In accordance with the instant invention, there is provided an ozone generator comprising an electrically insulating housing, a ground electrode positioned interior to the housing, a dielectric element positioned interior to the ground electrode and a high voltage electrode positioned interior to and spaced from the dielectric element to define a gap there between which comprises an air flow path through the ozone generator.

In one embodiment, the housing comprises at least two portions which are engagable to surround high voltage electrode, ground electrode and dielectric element within the housing.

In another embodiment, the housing comprises two portions, one of the portions having an air inlet provided therein and the other having an air outlet provided therein.

In accordance with the instant invention, there is also provided an ozone generator comprising an electrically insulating housing and a high voltage electrode, a ground electrode and a dielectric element positioned within the housing.

In one embodiment, the ozone generator is a tubular ozone generator.

In another embodiment, the dielectric element is positioned between the high voltage electrode and the ground electrode and the ground electrode is positioned exterior to the high voltage electrode whereby ozone is produced by corona discharge interior of the ground electrode provides a grounded layer interior of the housing.

In another embodiment, the housing surrounds the high voltage electrode and the ground electrode and the housing has first and second openings defining an air inlet and an air outlet, the ozone generator having an air flow path extending there through from the air inlet to the air outlet.

In another embodiment, the housing comprises at least two portions which are engagable to surround high voltage electrode, ground electrode and dielectric element within the housing.

In accordance with the instant invention, there is also provided a method of assembling an ozone generator comprising:

(a) preparing a first assembly comprising a first outer housing member with a dielectric element member and a ground electrode positioned therein, the first outer member having a first air flow passage there through;

(b) preparing a second assembly comprising a second outer housing member having a second air flow passage there through;

(c) providing a high voltage electrode as a portion of one of the assemblies; and

(d) bringing the first and second assemblies into engagement to produce the ozone generator.

### DESCRIPTION OF THE DRAWINGS

These and other advantages of the instant invention will be more fully and particularly understood in connection with the following description of the preferred embodiments of this invention in which:

FIG. 1 is a perspective view of the upstream end of an ozone generator according to the instant invention;

FIG. 2 is a perspective view of the downstream end of the ozone generator of FIG. 1;

FIG. 3 is an exploded view of the ozone generator of FIG. 1;

FIG. 4 is a partially cut away view of the upstream end of the ozone generator of FIG. 1; and,

FIG. 5 is a partially cut away view of the downstream end of the ozone generator of FIG. 1.

### DESCRIPTION OF THE PREFERRED EMBODIMENT

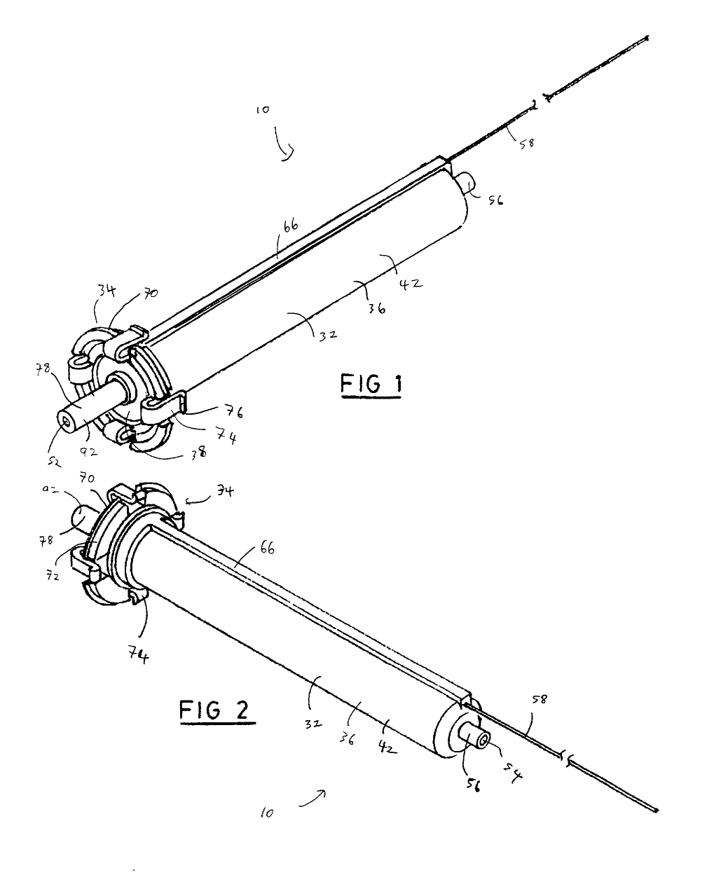

An ozone generator according to the instant invention is shown in FIGS. 1 and 2 and is generally designated by reference numeral 10.

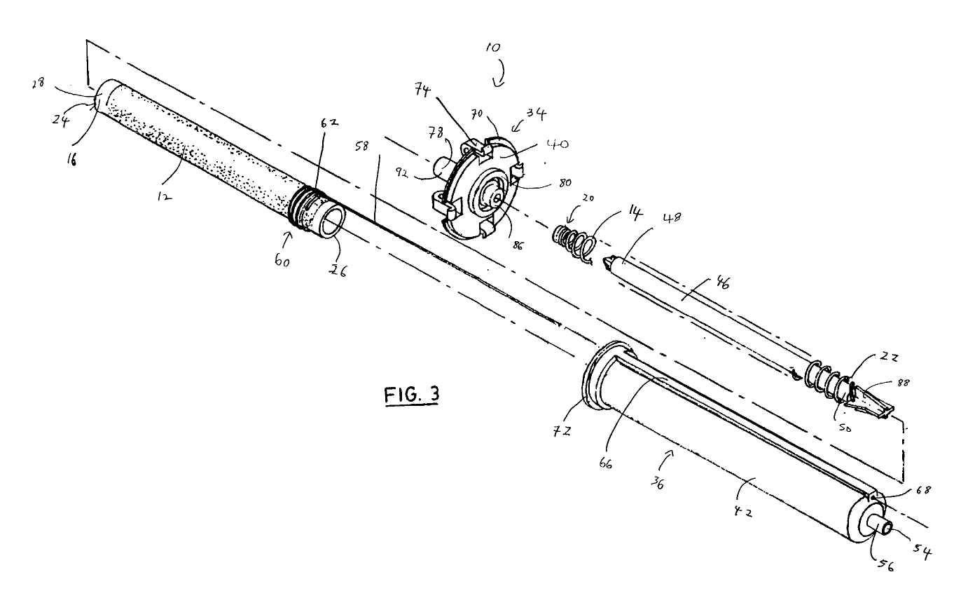

As shown in more detail in FIG. 3, ozone generator 10 comprises a ground electrode 12, a high voltage electrode 14 and a dielectric element 16. High voltage electrode 14 and ground electrode 12 may be made from any conductive material known in the field and may be of any particular configuration. Similarly, dielectric element 16 may be made from any known material and of any configuration known in the art. As shown in FIG. 3, dielectric element 16 is a ceramic tube having an upstream end 24, a downstream end 26, an outer surface 28 and an inner surface 30. Similarly, high voltage electrode 14 has an upstream end 20 and a downstream end 22.

In accordance with one aspect of the instant invention, an insulating housing is provided for ozone generator 10. Since ground electrode 12 is itself grounded by definition if housing 32 is constructed from a non-conductive material, then ozone generator 10 effectively has double insulation. This construction is safer than conventional ozone generators wherein ground electrode 12 forms part of the exterior housing of the ozone generator.

To this end, housing 32 is constructed from a non-conductive material (e.g. a plastic). Housing 32 preferably comprises a first portion 34 and a second portion 36. First portion 34 of housing 32 has an outer surface 38 and an inner surface 40. Second portion 36 may be made from the same or different material from first portion 34 and has an outer surface 42 and an inner surface 44. Housing 32 may be of any particular configuration that surrounds the portion of ozone generator 10 wherein the corona discharge occurs. Accordingly, ground electrode 12, high voltage electrode 14 and dielectric element 16 are mounted within a housing 32.

Preferably, housing 32 completely encases the electrodes so as to isolate electrodes 12 and 14 from the surrounding environment. Accordingly, housing 32 must itself have an air inlet 52 and an air outlet 54 so as to permit air to flow into ozone generator 10 and for ozone containing gas to exit housing 32. As shown in FIG. 2, air outlet 54 may comprise a tubular extension member 56 which is constructed integrally as part of second portion 36. Thus, unlike known ozone generators, ground electrode 12 does not form part of the exterior surface of ozone generator 10 and provides an exterior surface which may be safely handled when ozone generator is connected to an electric source.

It will be appreciated that housing 32 may be made from any number of portions which may be connected together by any means known in the art as to form a sealed enclosure surrounding electrodes 12 and 14 and dielectric element 16. Examples of such connection means includes an adhesive, welding, male and female engagable detent means provided on portions 34, 36 respectively or threaded portions may be provided on each portion 34, 36 so that one portion is threaded received on the other. The latter two options are preferred so that first and second portions 34 and 36 are releasably lockingly engaged to each other. Accordingly, ozone generator 10 may be disassembled by disengaging the locking means so that one of first and second portions 34 and 36 may be removed from the other thereby allowing the ozone generator to be serviced.

A preferred method of releasably lockingly engaging portions 34 and 36 together is by means of a friction fit. For example, inner surface 40 of first portion 34 may have an outer annular ring 70 which is recessed from inner surface 40. Second portion 36 has an outer annular ring 72 which is positioned and configured to be received on outer annular ring 70. Accordingly, when housing 32 is assembled by bringing members 34 and 36 into engagement to the position shown in FIG. 1, inner surface 40 is received inside housing 36 and ring 72 abuts against ring 70. Rings 70 and 72 are dimensioned so that the friction between the abutting surfaces of the rings holds portions 34, 36 in position subsequent to the assembly of housing 32.

It will be appreciated that housing 32 may be permanently sealed by welding, gluing or otherwise fixably adhering member 34 and 36 together. In particular, this may be achieved using the design of housing of the instant invention by applying an adhesive in ring 70 of first member 34 prior to joining housing 32 together or, alternately, by welding the exterior surface where rings 70 and 72 abut.

Ozone generator 10 may be mounted in position in an apparatus by any means known in the art. For example, a plurality of spaced apart latch members 74 having detent portions 76 may be provided on first portion 34 to releasably lockingly engage mating detent members provided in the apparatus (e.g. water purifier) in which ozone generator 10 is mounted.

A preferred construction of electrodes 12 and 14 and dielectric element 16 is shown in the drawings and comprises a second aspect of the instant invention. In the preferred embodiment, ozone generator 10 is of the tubular type. Accordingly, dielectric element 16 is positioned between high voltage electrode 14 and ground electrode 12.

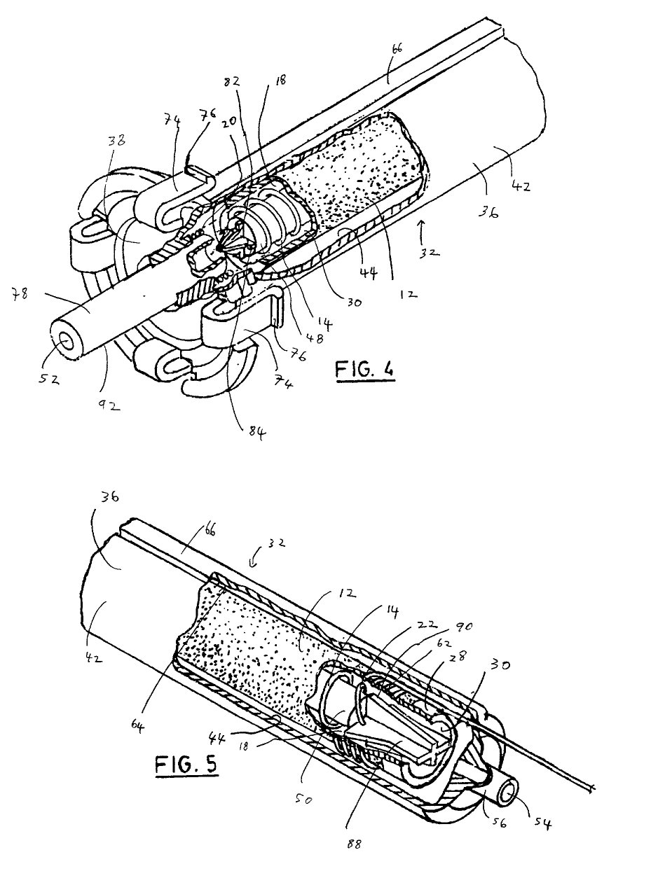

The air flows in ozone generator 10 from upstream end 20 of high voltage electrode 14 to downstream end 22. High voltage electrode 14 and ground electrode 12 are spaced apart so as to provide a gap 18 which provides the air flow path through ozone generator 10. As shown in particular in FIGS. 4 and 5, high voltage electrode 14 is received within dielectric element 16 and spaced therefrom so as to define gap or air flow path 18 between high voltage electrode 14 and inner surface 30 of dielectric element 16.

Preferably, as shown in FIGS. 3-5, high voltage electrode 14 is a coiled high voltage electrode which may be prepared from, for example, 0.03 inch stainless steel welding wire which is wound into a spring. When constructed in this way, high voltage electrode 14 is not necessarily a self supporting member. Further, even if it has sufficient structural integrity to be a self supporting member, means are preferably provided to maintain high voltage electrode 14 in a fixed spaced relationship from ground electrode 12. Accordingly, a support member 46 having an upstream end 48 and downstream 50 may be provided. High voltage electrode 14 may be first wound and then inserted over support member 46. Alternately, a conductive wire may be wound around support member 46 to produce a spiral or coiled high voltage electrode. Preferably, the length and pitch of such a spiral high voltage electrode is selected so that the impedance of the high voltage electrode matches the impedance of the source of high voltage to which high voltage electrode 14 is electrically connected.

Ground electrode 12 may be prepared such as by applying a conductive coating (e.g. by means of spray deposition or the like) to outer surface 28 of dielectric element 16. It will be appreciated that ground electrode 12 may be a separate self supporting element from dielectric element 16.

Ozone generator further comprises means for grounding ground electrode 12. In the preferred embodiment, grounding member 58, which is constructed from an elongate conductive member, is provided. For example, grounding member 58 may be a stainless steel wire. Grounding member 58 may be affixed to ground electrode 12 by any means known in the art, eg. by means of adhesive, a screw or welding. Preferably, as shown in FIGS. 3 and 5, end 60 of grounding member 58 is wrapped around downstream end of dielectric element 26 (e.g. two to four wraps) to thereby lockingly engage ground electrode 12. These coils 62 provide sufficient physical connection with ground electrode 12 so that grounding member 58 remains electrically connected to ground electrode 12 during the operation of ozone generator 10.

Inner surface 44 of second portion 36 of housing 32 preferably has a recessed area to define a channel through which grounding member 58 passes. This channel 64 is provided immediately beneath raised portion 66 as shown in particular in FIG. 5. Raised portion 66 has an opening 68 (see FIG. 3) which allows grounding member 58 to extend there through. The portion of grounding member 58 which extends exterior to ozone generator 10 may be connected to any suitable ground plane in the apparatus within which ozone generator 10 is mounted. A sealing member, such as silicone or an gas impervious material may be provided adjacent opening 68 to prevent the escape of any gas from ozone generator 10 via opening 68.

High voltage electrode 14 may be affixed to a source of electric current by any means known in the art. Preferably, as shown in particular in FIG. 4, tubular member 78 extends through an opening provided centrally in first portion 34. Tubular member 78 is made from a material which is electrically conductive. As shown in FIG. 3, upstream end 20 of high voltage electrode 14 has a plurality of windings or coils which are of a smaller diameter than the remainder of high voltage electrode 14. Referring in particular to FIG. 4, these narrower diameter windings 14 are received on tubular member 78. Accordingly, when exterior portion 92 of tubular member 78 is connected to an electrical source, the current may be transferred to high voltage electrode 14 via tubular member 78.

Inner surface 40 of first portion 34 has a raised annular member 80. Dielectric element 26 is received on raised annular member 80. In particular, the outer diameter of raised annular member 80 is preferably only slightly smaller than the inner diameter of dielectric element 16 so that the physical engagement between inner surface 30 of dielectric element 16 and raised annular member 80 holds upstream end 24 of dielectric element 16 in position on first portion 34 by means of a friction fit. Optionally an 0-ring may be provided to create an air tight seal between dielectric element 16 and first portion 34. Downstream end 26 of dielectric element 16 is received in second portion 36 of housing 32 adjacent air outlet 54 and preferably abuts against second portion 36. Thus each end of dielectric element 16, and therefore ground electrode 12, is supported in position in housing 32.

In order to maintain high voltage electrode 14 in position with respect to ground electrode 12, positioning means are provided to position support member 46, and therefore high voltage electrode 14, centrally within dielectric element 16. Referring to FIG. 4, upstream end 48 of support member 46 is provided with a plurality of longitudinally extending tapered ribs 82. Ribs 82 have a transversely extending portion 84 which abut against lateral surface 86 of tubular member 78. Tapered ribs 82 extend into air inlet 52 which extends through tubular member 78. Accordingly, the spacing between the tapered ribs provides an air flow path so that air may flow from air inlet 52 past ribs 82 into air flow path 18. The engagement of ribs 82 in air inlet 52 supports upstream end 48 of support member 46 (and accordingly high voltage electrode 14) centrally within dielectric element 16.

Downstream portion 50 of support 46 is provided with a further plurality of spaced apart ribs 88 (see FIG. 5). Ribs 88 has at least a portion which are sized so as to be slightly smaller than the inner diameter of dielectric element 16 so that surface 90 of ribs 88 abuts against inner surface 30 of dielectric element 16 thus positioning downstream end 50 of support member 46 (and accordingly high voltage electrode 14) centrally within dielectric element 16. As ribs 88 are spaced apart, they provide an air flow path for air to travel from gap 18, past ribs 88 to air outlet 54.

In practice, ozone generator 10 may be assembled as follows. A first assembly is prepared comprising high voltage electrode 14 and support member 46. High voltage electrode 14 may be prepared by winding a suitable conductive member to form high voltage electrode 14 and then slipping high voltage electrode 14 over support member 46 from upstream end 48 to downstream end 50. Alternately, high voltage electrode 14 may be wound around support 46. Upstream portion 20 of high voltage electrode 14 is affixed to tubular member 78 to complete the assembly of the first assembly.

A second assembly is prepared comprising ground electrode 12 and dielectric element 16. Ground electrode 12 is prepared such as by spraying a conductive metallic coating on outer surface 28 of dielectric element 16. Grounding member 58 may then be wound around upstream end 26 of ground electrode 12 to produce coils 62. Dielectric element 16 is then inserted into second portion 36 of housing 32 such that grounding member 58 extends through opening 68 to complete the assembly of the second assembly.

The final assembly step then involves inserting high voltage electrode 14 with support member 46 into dielectric element 16. First and second portions 34 and 36 of housing 32 are then brought into contact thereby completing the assembly of ozone generator 10. It will be appreciated that high voltage electrode 14 may be inserted into dielectric element 16 so as to from part of the second assembly and when first and second portions 34, 36 are brought into engagement, high voltage electrode is electrically connected to tubular member 78.

As an optional final assembly step, housing 32 may be sealed such as by welding portions 32 and 43 together. Thus ozone generator may be operated under an elevated pressure (eg. 2-5 atm) to provide enhanced ozone production.

It will be appreciated that various modifications and alterations may be made to the ozone generator and all of these modifications and alterations are within the scope of this invention.

I claim:

1. An ozone generator comprising an electrically insulating housing, a ground electrode positioned interior to the housing, a dielectric element positioned interior to the ground electrode and a high voltage electrode positioned interior to and spaced from the dielectric element to define a gap there between which comprises an air flow path through the ozone generator.

2. The ozone generator as claimed in claim 1 wherein the housing comprises at least two portions which are engagable to surround high voltage electrode, ground electrode and dielectric element within the housing.

3. The ozone generator as claimed in claim 1 wherein the housing comprises two portions, one of the portions having an air inlet provided therein and the other having an air outlet provided therein.

4. An ozone generator comprising an electrically insulating housing and a high voltage electrode, a ground electrode and a dielectric element positioned within the housing.

5. The ozone generator as claimed in claim 5 wherein the ozone generator is a tubular ozone generator.

6. The ozone generator as claimed in claim 5 wherein the dielectric element is positioned between the high voltage electrode and the ground electrode and the ground electrode is positioned exterior to the high voltage electrode whereby ozone is produced by corona discharge interior of the ground electrode provides a grounded layer interior of the housing.

7. The ozone generator as claimed in claim 5 wherein the housing surrounds the high voltage electrode and the ground electrode and the housing has first and second openings defining an air inlet and an air outlet, the ozone generator having an air flow path extending there through from the air inlet to the air outlet.

8. The ozone generator as claimed in claim 5 wherein the housing comprises at least two portions which are engagable to surround high voltage electrode, ground electrode and dielectric element within the housing.

9. A method of assembling an ozone generator comprising:
(a) preparing a first assembly comprising a first outer housing member with a dielectric element member and a ground electrode positioned therein, the first outer member having a first air flow passage there through;
(b) preparing a second assembly comprising a second outer housing member having a second air flow passage there through;
(c) providing a high voltage electrode as a portion of one of the assemblies; and
(d) bringing the first and second assemblies into engagement to produce the ozone generator.
